(19) United States
(12) Patent Application Publication
(10) Pub. No.: US 2025/0122430 A1
(43) Pub. Date: Apr. 17, 2025

(54) METAL CARBIDE-BASED CATALYST SYSTEMS FOR PLASTIC RECYCLING

(71) Applicants: IOWA STATE UNIVERSITY RESEARCH FOUNDATION, INC., Ames, IA (US); LOUISIANA TECH RESEARCH CORPORATION; A DIVISION OF LOUISIANA TECH UNIVERSITY FOUNDATION, INC, Ruston, LA (US)

(72) Inventors: Yue WU, Ames, IA (US); Xiaopeng LIU, Ames, IA (US); Yang XIAO, Ruston, LA (US); Tobias K. MISICKO, Hinsdale, IL (US)

(73) Assignees: IOWA STATE UNIVERSITY RESEARCH FOUNDATION, INC., Ames, IA (US); LOUISIANA TECH RESEARCH CORPORATION; A DIVISION OF LOUISIANA TECH UNIVERSITY FOUNDATION, INC, Ruston, LA (US)

(21) Appl. No.: 18/913,376

(22) Filed: Oct. 11, 2024

Related U.S. Application Data
(60) Provisional application No. 63/589,495, filed on Oct. 11, 2023.

(51) Int. Cl. C10G 47/14; B01J 23/42; B01J 23/72; B01J 27/22; B01J 37/08; B01J 37/18; C10L 1/04

(52) U.S. Cl. CPC C10G 47/14; B01J 23/42; B01J 23/72; B01J 27/22; B01J 37/08; B01J 37/18; C10L 1/04; C10G 2300/1003; C10G 2300/703

(57) ABSTRACT

Catalysts and methods for catalytic hydrogenolysis of a polymer. The method comprises a) activating a catalyst with a hydrogen source to provide an activated catalyst, wherein the catalyst comprises: i) a MXene support of Formula I: Mₙ₊₁XₙTₓ (I); wherein each M is independently an early transition metal; X is carbon or nitrogen; Tₓ is a surface functional group wherein x is 0-10; and n is 1, 2, 3, or 4; and ii) a supported metal, wherein loading of the supported metal on the MXene support is less than 5% w/w based on the weight of the catalyst; and b) contacting a mixture of the activated catalyst, hydrogen gas, and a polymer at a temperature of at least about 200° C. for a period of time that is sufficient for catalytic hydrogenolysis of the polymer; thereby converting the polymer to a fuel.

### RELATED APPLICATIONS

This application claims priority under 35 U.S.C. § 119 (c) to U.S. Provisional Patent Application No. 63/589,495 filed Oct. 11, 2023, which is incorporated herein by reference.

### BACKGROUND OF THE INVENTION

The amount of plastic waste has grown exponentially over the past 60 years. Only about 9% of plastic waste is recycled and 12% is incinerated. The rest, about 6 billion tons, have accumulated as waste in landfills, ground water, or the oceans, where the waste degrades slowly over decades or centuries into microplastics, releasing toxic chemicals into the environment. The state-of-the-art separation technologies for removing microplastics and toxic chemicals from water cost about $0.003 per gallon. Because the oceans have 3.5×10²⁰ gallons of water, removing plastic waste, microplastics, and their degradation products from the oceans would cost about 10,000 times the global GDP. Plastic wastes have been found everywhere, in beach sands, in the ice of the two poles, the snow near the peak of Mount Everest, the floors of the oceans, and the Mariana Trench. Microplastics have been found in air, water, beach sands, sea salts, fish, birds, plant roots, and recently in human organs (such as placenta and lungs). This plastic pollution is a more urgent threat to life on land or below water than climate change, and it is imperative to reduce plastic waste input into oceans, landfills, and the environment.

Globally, the majority (about 63%) of plastic waste is polyolefins. More than 220 million tons of polyolefin (PE and PP) waste have been generated annually since 2010. The impacts of COVID-19 have further increased polyolefin production rates due to higher demands for polyolefin masks and medical gowns. Polyolefins have a very short in-use lifetime (<6 months) and a low waste collection rate, <8%. Almost all polyolefin packaging films are currently landfilled after a single use. For these reasons, our recent research is focused on the conversion of polyolefin and polystyrene waste into naphtha (a chemical feedstock) or transportation fuels.

Conventional treatment methods of incineration, mechanical recycling, and pyrolysis are ineffective for reducing the amounts of polyolefin or other plastic waste. Incineration releases greenhouse gases and toxic gases, has low energy recovery (<20%), and requires tipping fees ($15 to $20/ton) to offset the processing costs. Mechanical recycling of mixed waste typically results in dark-colored, lower-value products, which have limited uses. After a few cycles, polymer properties degrade, and the waste products must be landfilled or incinerated. Pyrolysis can convert mixed polyolefin waste to oil, but it has a relatively low yield (<70%) without the use of catalysts. Fast pyrolysis also generates significant amounts of polycyclic aromatic hydrocarbons (PAH) and char (up to 50%), which cause catalyst fouling and high maintenance costs. The oils from pyrolysis also need to be transported to refineries for extensive upgrading and separation for producing transportation fuels or other products.

For these reasons, only 2% of plastic waste in the US is currently remade into products for the originally intended applications; 98% of new plastic products are made from virgin feedstocks. Efficient and economical methods need to be developed for converting plastic waste into useful and valuable products, which would create a market driving force for reducing the amount of plastic waste and plastic pollution in the environment.

### SUMMARY

Aiming to find a practical solution to recycle plastics, we developed a method for the catalytic hydrogenolysis conversion of polyethylene (PE) to gasoline- and diesel-range fuels with a narrow carbon number distribution.

Accordingly, this disclosure provides a method for catalytic hydrogenolysis of a polymer comprising:
a) activating a catalyst with a hydrogen source to provide an activated catalyst, wherein the catalyst comprises:
   i) a MXene support of Formula I:

Mₙ₊₁XₙTₓ (I);
wherein each M is independently an early transition metal; X is carbon or nitrogen; Tₓ is a surface functional group wherein x is 0-10; and n is 1, 2, 3, or 4; and
   ii) a supported metal, wherein atoms of the supported metal occupy crystal lattice nodes at the basal plane of the MXene support, the atoms of the supported metal are supported by a metallic bond to the early transition metal, the supported metal has one to five nanostructured layers of its atoms on the MXene support, and loading of the supported metal on the MXene support is less than about 5% w/w, based on the weight of the catalyst; and
b) contacting a mixture of the activated catalyst, hydrogen gas, and a polymer at a temperature of at least about 200° C., optionally in the presence of an inert gas, for a period of time that is sufficient for catalytic hydrogenolysis of the polymer; thereby converting the polymer to a fuel, such as a gasoline-range fuel (C₄-C₁₂), a diesel-range fuel (C₁₃-C₂₀), or a combination thereof.

In some embodiments, the supported metal is copper and the MXene support is Mo₂TiC₂Tₓ or W₂TiC₂Tₓ. In various embodiments, the polymer is a polyolefin such as polyethylene or polypropylene.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Synthesis steps of W₂TiC₂Tₓ. Schematic illustration of the sintering, etching, and delamination steps of MXene Synthesis.

FIG. 2. Synthesis steps of Mo₂TiC₂Tₓ. Schematic illustration for the preparation of Mo₂TiC₂Tₓ MXene (doi.org/10.1007/s12274-021-3660-0).

FIG. 3. XRD patterns of W₂ TiAlC₂Tₓ, W₂TiC₂Tₓ, and delaminated W₂TiC₂Tₓ MXene (d-W₂TiC₂Tₓ).

FIG. 4A-E. Theoretical XRD of (a) W₂TiAlC₂Tₓ and (b) W₂TiC₂Tₓ simulated by VESTA; comparison of experimental and calculated XRD from 2θ=5° to 70° of (c) W₂TiAlC₂Tₓ and (d) W₂TiC₂Tₓ; and (e) lattice structure model of W₂TiAlC₂Tₓ and W₂TiC₂Tₓ for the simulation.

FIG. 5. SEM image of (a) W₂TiAlC₂Tₓ precursor and (b) W₂TiC₂Tₓ MXene.

FIG. 6. TEM images of W₂TiC₂Tₓ MXene.

FIG. 7. TEM images of (a, b) Cu/W₂TiC₂Tₓ, (c) Co/W₂TiC₂Tₓ, and (d) Pt/W₂TiC₂Tₓ.

FIG. 8. Selected area electron diffraction (SAED) pattern of the W₂TiC₂Tₓ MXene (loaded with Co).

FIG. 9. Atomic resolution HAADF-STEM image showing structure of W₂TiC₂Tₓ MXene loaded with (a) Co and (b) Cu.

FIG. 10. EDS mappings for W, Ti, C, O, and Co on Co/W₂TiC₂Tₓ.

FIG. 11. EDS mappings for W, Ti C, O, and Cu on Cu/W₂TiC₂Tₓ.

FIG. 12. 1 keV He+ ISS spectra from Cu/W₂TiC₂Tₓ.

FIG. 13. XRD patterns of Mo₂ TiAlC₂Tₓ, Mo₂TiC₂Tₓ, and comparison with previously reported Mo₂TiC₂Tₓ.

FIG. 14. SEM image of MoTiC₂Tₓ MXene.

FIG. 15. SEM-EDS image of MoTiC₂Tₓ MXene.

FIG. 16. TEM images of Mo₂TiC₂Tₓ MXene.

FIG. 17A-D. TEM images of Mo₂TiC₂Tₓ loaded with (a, b) Ni and (c, d) Cu.

FIG. 18A-D. Two-dimensional MXene catalysts for hydrogenolysis of polyethylene (PE) to gasoline-range and diesel-range fuels with a narrower carbon number distribution; reaction time: 8 hours: (a) 0.5% Pt/Mo₂TiC₂, (b) 0.5% Cu/Mo₂TiC₂, (c) 0.5% Cu-5% WO₃/Mo₂TiC₂, and (d) 0.5% Cu/W₂TiC₂.

### DETAILED DESCRIPTION

Atomically thin nanolayers of Cu or Pt were synthesized on the surface of Mo₂TiC₂ MXenes or W₂TiC₂Tₓ MXene and used for the catalytic hydrogenolysis of a polyolefin. The metal-support interaction is found to be dependent on the substrate and metal components, providing wide opportunities to explore high-performance MXene-supported metallic catalysts.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability, necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2, 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated herein.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a chemical reaction or a physical change, e.g., in a solution or in a reaction mixture.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

The term “fuel” refers to a substance that is used to produce heat or power by burning, including C₂-C₂₀ alkanes such as gasoline, diesel fuel, kerosene, naphtha, petroleum, and the like.

The phrase “period 6 transition metal” refers to transition metals along period 6 of the periodic table and within groups 3 to 11.

Transition metals in the compositions described herein (e.g., MXene supports) are classified by a 3-way classification system and transition metals in methods described herein (e.g., methods of using a broader category of MXene supports) are classified by a 2-way classification system. In the 2-way classification, the term “early transition metal(s)” refers to elements of groups 3, 4, 5, 6 and 7 of the periodic table; and the term “late transition metal(s)” refers to elements of groups 8, 9, 10, and 11 of the periodic table. In the 3-way classification, the term “early transition metal(s)” refers to elements of groups 3, 4, and 5 of the periodic table; the term “middle transition metal(s)” refers to elements of groups 6, 7, and 8 of the periodic table, and the term “late transition metal(s)” refers to elements of groups 9, 10, and 11 of the periodic table.

### Embodiments of the Technology.

This disclosure provides an annealed catalyst comprising a delaminated MXene support of Formula IA:

Mₙ₊₁XₙTₓ (IA);
wherein
   M is a combination of a period 6 transition metal and an early transition metal;
   X is a non-metal wherein the non-metal is carbon or nitrogen;
   Tₓ is a surface functional group wherein x is 0-10; and
   n is 1-4; or n is 2 or 3; and
late transition metal nanoparticles having a particle size of about 0.5 nm to about 2.0 nm, wherein less than 5 weight percent of the late transition metal nanoparticles are uniformly distributed onto a basal plane of the MXene support, based on the weight of the catalyst;
wherein metal support interactions at an interface of atoms of the late transition metal nanoparticles and atoms of the period 6 transition metal are present in the catalyst.

In some embodiments, about 3.5 weight percent to about 4.5 weight percent of the late transition metal nanoparticles are uniformly distributed onto the MXene support. In some embodiments, the late transition metal nanoparticles have a particle size of about 0.8 nm to about 1.0 nm. In some embodiments, the late transition metal nanoparticles are more than about 50% metallic and/or less than about 50% oxidized. In some embodiments, the late transition metal nanoparticles are about 100% metallic.

In some embodiments, the annealed catalyst was annealed at about 450° C. to about 750° C. In some embodiments, the annealed catalyst was annealed at about 700° C. In some embodiments, the metal support interactions are d-band metal support interactions.

In some embodiments, the late transition metal nanoparticles consist of one to five layers of its atoms positioned on the basal plane of the MXene support. In some embodiments, the period 6 transition metal is tungsten; or the early transition metal is titanium; or the period 6 transition metal is tungsten and the early transition metal is titanium. In some embodiments, X is carbon and n is 2; or X is carbon, n is 2, and x is 0.

In some embodiments, the delaminated MXene support of Formula IA comprises Formula IIA:

W₂TiC₂ (IIA),

wherein the delaminated MXene support comprises a layer of tungsten atoms, a layer of carbon atoms, and a layer of titanium atoms (and multiple layers of each can be present). The layers alternate in the sequence W—C—Ti—C to form a layer of titanium atoms in-between two layers of carbon atoms that are sandwiched together between two layers of tungsten atoms. In some embodiments, the late transition metal nanoparticles are cobalt metal nanoparticles. In some embodiments, the late transition metal nanoparticles are copper nanoparticles or platinum nanoparticles.

This disclosure also provides a delaminated MXene support of Formula IA:

Mₙ₊₁XₙTₓ (IA);
wherein
   M is a combination of a period 6 transition metal and an early transition metal;
   X is a non-metal wherein the non-metal is carbon or nitrogen;
   Tₓ is a surface functional group wherein x is 0-10; and
   n is 2 or 3.

In some embodiments, the early transition metal is titanium, hafnium, niobium, tantalum, vanadium, zirconium, or a combination thereof. In some embodiments, the period 6 transition metal is hafnium, tantalum, iridium, tungsten, or a combination thereof. In certain embodiments, M is chromium, molybdenum, or tungsten.

In some embodiments, the delaminated MXene support further comprises a supported layer of late transition metal nanoparticles. In some embodiments, the supported metal is copper, palladium, platinum, cobalt, nickel, or a combination thereof.

In some embodiments, the delaminated MXene support comprises Formula IIA:

W₂TiC₂ (IIA),
wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms.

Furthermore, this disclosure provides a method for catalytic hydrogenolysis of a polymer comprising:
a) activating a catalyst with a hydrogen source to provide an activated catalyst, wherein the catalyst comprises:
   i) a MXene support of Formula I:

Mₙ₊₁XₙTₓ (I);
wherein each M is independently an early transition metal; X is carbon or nitrogen; Tₓ is a surface functional group wherein x is 0-10; and n is 1, 2, 3, or 4; and
   ii) a supported metal, wherein atoms of the supported metal occupy crystal lattice nodes at the basal plane of the MXene support, the atoms of the supported metal are supported by a metallic bond to the early transition metal, the supported metal has one to five nanostructured layers of its atoms on the MXene support, and loading of the supported metal on the MXene support is less than 5% w/w based on the weight of the catalyst; and
b) contacting a mixture of the activated catalyst, hydrogen gas, and a polymer at a temperature of at least about 200° C., optionally in the presence of an inert gas, for a period of time that is sufficient for catalytic hydrogenolysis of the polymer; thereby converting the polymer to a fuel, such as a gasoline-range fuel (C₄-C₁₂), a diesel-range fuel (C₁₃-C₂₀), or a combination thereof.

In some embodiments, M is a combination of a middle transition metal and an early transition metal. In some embodiments, n is 2 or 3. In some embodiments, the noble metal is copper, cobalt, platinum, iridium, rhodium, palladium, ruthenium, or a combination thereof. In a preferred embodiment, the noble metal is copper. In some embodiments, M is hafnium, niobium, molybdenum, chromium, titanium, tungsten, tantalum, vanadium, zirconium, or a combination thereof. In some embodiments, M is a combination of molybdenum and titanium or tungsten and titanium. In some embodiments, the surface functional group (Tₓ) is halo, hydroxyl, oxo, or a combination thereof. In some embodiments, the MXene support is Mo₂TiC₂ Tₓ or W₂TiC₂Tₓ.

In some embodiments, the loading of the supported metal on the MXene support is about 0.1 wt. % to about 4 wt. %. In other embodiments, the loading is about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, or about 5.0 wt. %, or an range between any two of the preceding recited values, with respect to the weight of the catalyst.

In some embodiments, the catalyst comprises about 0.1 wt. % to about 2 wt. % of the supported metal (for example, copper) loaded on a Mo₂TiC₂Tₓ support or W₂TiC₂Tₓ support. In various embodiments, the wt. % of the supported metal loading is about 0.2, about 0.3, about 0.4, about 0.5, about 0.6, about 0.7, about 0.8, about 0.9, about 1.0, about 1.2, about 1.4, about 1.6, about 1.8, about 2.0, about 2.5, or about 3.0 wt. %, or an range between any two of the preceding recited values.

In some embodiments, the catalyst is a Mo₂TiC₂Tₓ support loaded with copper or platinum, wherein the copper or platinum loading is about 0.1 wt. % to about 2 wt. %. In preferred embodiments, the copper or platinum loading is about 0.5 wt. %.

In some embodiments, the catalyst is a Mo₂TiC₂Tₓ support loaded with copper, wherein the copper loading is about 0.3 wt. % to about 0.7 wt. %, or about 0.4 wt. % to about 0.6 wt. %. In some embodiments, the catalyst is a W₂TiC₂Tₓ support loaded with copper, wherein the copper loading is about 0.3 wt. % to about 0.7 wt. %, or about 0.4 wt. % to about 0.6 wt. %. In some embodiments, the catalyst further comprises about 3 wt. % to about 8 wt. % of WO₃, or about 0.4 wt. %, about 0.5 wt. %, about 0.6 wt. %, or about 0.7 wt. % of WO₃.

In various embodiments, activating the catalyst comprises heating the catalyst and the hydrogen source at an (activating) temperature above 250° C. In some embodiments, the hydrogen source is optionally about a 2% v/v to about a 20% v/v mixture of hydrogen gas in combination with an inert gas.

In various embodiments, activating the catalyst includes heating the catalyst to an activating temperature. In some embodiments, the activating temperature is about 300° C., about 350° C., about 400° C., about 450° C., about 500° C., about 550° C., or about 600° C., or a range between any two of the aforementioned temperatures.

In various embodiments, the polymer comprises or is a polyolefin. In various embodiments, the polymer is polyethylene, polypropylene, or a combination thereof. In some embodiments, the mixture (after heating) is at a temperature of about 225° C. to about 475° C. In some embodiments, the mixture (after heating) is at a temperature of about 250° C. to about 350° C., or at a temperature of about 400° C. to about 450° C.

In some embodiments, the mixture is heated at a temperature of about 300° C. to about 800° C. In various embodiments, the heating temperature is about 200° C., about 250° C., about 300° C., about 350° C., about 400° C., about 450° C., about 500° C., about 550° C., about 600° C., about 650° C., about 700° C., about 750° C., or about 800° C., or a range between any two of the aforementioned temperatures. In some embodiments, the mixture is heated at a temperature of about 500° C. to about 650° C.

In some embodiments, the hydrogen gas has a flow rate of about 25 cc/min to about 75 cc/min, and the mixture has a pressure of about 1 bar. In other embodiments, the hydrogen gas flow rate is about 30 cc/min, about 40 cc/min, about 50 cc/min, about 60 cc/min, or about 70 cc/min.

In some embodiments, the contacting is at a gas hourly space velocity (GHSV) of about 100 cc/min to about 300 cc/min. In other embodiments, GHSV is about 50 cc/min, about 100 cc/min, about 150 cc/min, about 200 cc/min, about 250 cc/min, about 300 cc/min, about 350 cc/min, or about 400 cc/min.

In some embodiments, an amount of the contacted activated catalyst is about 100 mg to about 300 mg, typically about 50 cc/min to about 150 cc/min per 100 mg of catalyst. In various embodiments, the amount is about 100 mg, about 150 mg, about 200 mg, about 250 mg, about 300 mg, about 350 mg, about 400 mg, about 450 mg, or about 500 mg, or a range between any two of the aforementioned values.

Also, this disclosure provides a method for catalytic hydrogenolysis of a polyolefin comprising:
a) activating a catalyst by heating the catalyst in the presence of hydrogen gas to provide an activated catalyst, wherein the catalyst comprises:
   i) a MXene support represented by Formula (II):

Mo₂TiC₂Tₓ (II);
wherein Tₓ is a surface functional group wherein x is 0-10; and
   ii) copper metal, wherein atoms of the copper metal occupy crystal lattice nodes at the basal plane of the MXene support, the atoms of the copper metal are supported by a metallic bond to the molybdenum atom of the MXene support, the copper metal has one to five nanostructured layers of its atoms on the MXene support, and loading of the copper metal on the MXene support is less than 2% w/w based on the weight of the catalyst; and
b) contacting a mixture of the activated catalyst, hydrogen gas, and a polyolefin at a temperature of at least about 200° C. for a period of time that is sufficient for catalytic hydrogenolysis of the polyolefin; thereby converting the polyolefin to a fuel, such as a gasoline-range fuel (C₄-C₁₂), a diesel-range fuel (C₁₃-C₂₀), or a combination thereof.

Additionally, this disclosure provides a method for catalytic hydrogenolysis of a polyolefin comprising:
a) activating a catalyst by heating the catalyst in the presence of hydrogen gas to provide an activated catalyst, wherein the catalyst comprises:
   i) a MXene support represented by Formula (III):

W₂TiC₂Tₓ (III);
wherein Tₓ is a surface functional group wherein x is 0-10; and
   ii) copper metal, wherein atoms of the copper metal occupy crystal lattice nodes at the basal plane of the MXene support, the atoms of the copper metal are supported by a metallic bond to the tungsten atom of the MXene support, the copper metal has one to five nanostructured layers of its atoms on the MXene support, and loading of the copper metal on the MXene support is less than 2% w/w based on the weight of the catalyst; and
b) contacting a mixture of the activated catalyst, hydrogen gas, and a polyolefin at a temperature of at least about 200° C. for a period of time that is sufficient for catalytic hydrogenolysis of the polyolefin; thereby converting the polyolefin to a fuel, such as a gasoline-range fuel (C₄-C₁₂), a diesel-range fuel (C₁₃-C₂₀), or a combination thereof.

In addition, this disclosure provides a catalyst comprising an MXene support of Formula I, II, or III:

Mₙ₊₁XₙTₓ (I),

Mo₂TiC₂Tₓ (II) or

W₂TiC₂Tₓ (III);

wherein,
each M is independently an early transition metal; X is a non-metal, such as carbon or nitrogen; Tₓ is a surface functional group wherein x is 0-10; and n is 1, 2, 3, or 4 (or as defined in the embodiments above for each variable); and
a supported metal, such as copper or cobalt, wherein atoms of the supported metal occupy crystal lattice nodes at the basal plane of the MXene support, the atoms of the supported metal are supported by a metallic bond to the early transition metal (M of Formula I, Mo of Formula II, or W of Formula III) of the MXene support;
wherein the supported metal has one to five nanostructured layers of its atoms on the MXene support, and loading of the supported metal on the MXene support is less than 5% w/w based on the weight of the catalyst.

In some embodiments, the occupied crystal lattice node is a hexagonal close packed (HCP) crystal lattice node. In some embodiments, the non-metal occupies a crystal lattice node between the early transition metal and a different second early transition metal that occupies another crystal lattice node.

In some embodiments, the supported metal has one, two, three, or four nanostructured layers of its atoms on the MXene support. In some embodiments, the supported metal has one or two nanostructured layers of its atoms on the MXene support.

In some embodiments, the one to five nanostructure layers of the supported metal have an average thickness of about 0.3 nanometers.

In some other embodiments, the loading is about 0.1 weight percent to about 2.5 weight percent. In some embodiments, the catalyst has a surface area of about 20 m²/g to about 40 m²/g. In some embodiments, the catalyst has a pore size of about 0.5 nm to about 5 nm. In some embodiments, the catalyst has a pore volume of about 0.02 cm³/g to about 0.1 cm³/g.

### Results and Discussion.

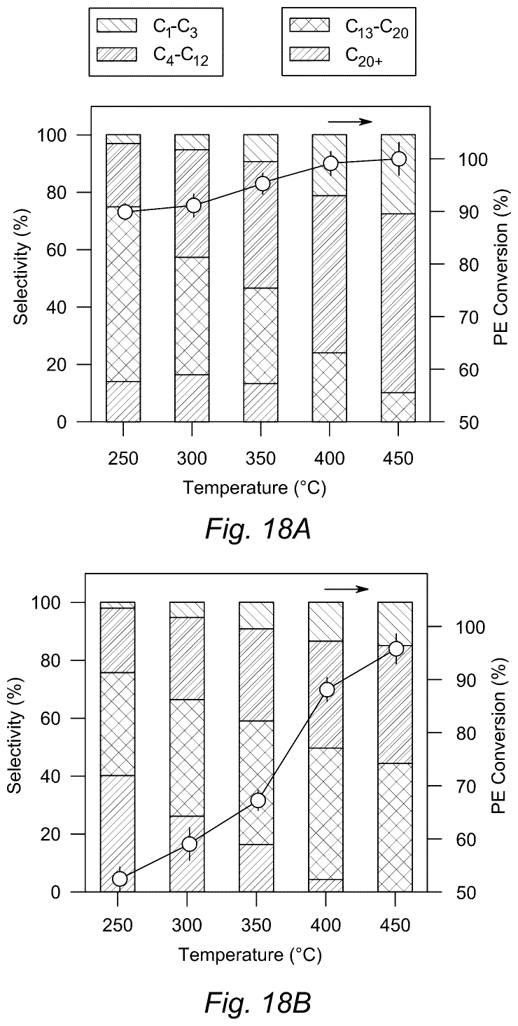

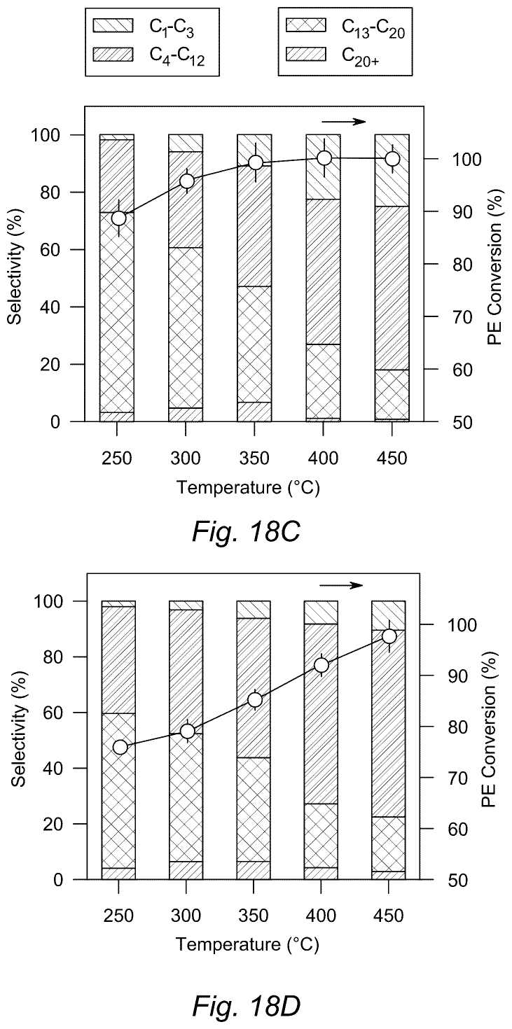

We have developed catalytic hydrogenolysis conversion of polyethylene (PE) to gasoline- and diesel-range fuels with a narrower carbon number distribution, as shown in FIG. 18. Using the 0.5% Pt/Mo₂TiC₂ MXene catalyst, the effect of reaction temperature is plotted in FIG. 18a. The PE conversion is 90-100% at 250-450° C. The yields of gasoline-range fuels (C₄-C₁₂) and diesel-range fuels (C₁₃-C₂₀) are 22.1% and 60.4%, respectively.

To decrease the cost of catalysts, we further investigated 0.5% Cu/Mo₂TiC₂ MXene catalyst in FIG. 18b. However, the PE conversion drops to 50-60% at 250-350° C. In principle, PE hydrogenolysis is promoted by both acidic and metallic sites of a catalyst. Thus, we prepared a bifunctional 0.5% Cu-5% WO₃/Mo₂TiC₂ MXene catalyst and tested it for PE hydrogenolysis, in which WO₃ provided acidic sites. As shown in FIG. 18c, the 0.5% Cu-5% WO₃/Mo₂TiC₂ MXene catalyst exhibits comparable performance with Pt-containing catalysts. At 250° C., the PE conversion is about 88.6%, while the yields of gasoline-range fuels (C₄-C₁₂) and diesel-range fuels (C₁₃-C₂₀) are 25.2% and 69.6%. Remarkably, the 0.5% Cu/W₂TiC₂ catalyst (FIG. 18d), which has both acidic and metallic active sites, exhibited a lower PE conversion at 250° C., but a comparable PE conversion at 400-450° C. with a higher selectivity to gasoline-like fuels and a lower selectivity to diesel-like fuels.

Additional information and data supporting aspects of the invention are described by U.S. Pat. No. 11,524,279 (Li), U.S. Publication No. 2024/0140886 (Wu), and Li et al., Nano Res. 17, 1251-1258 (2024) (doi.org/10.1007/s12274-023-6022-2) and its Supporting Information, which, patent, patent publication, scientific publication are incorporated herein by reference.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. W₂TiC₂Tₓ and Mo₂TiC₂Tₓ Synthesis and Characterization

Synthesis of W₂TiAlC₂Tₓ and W₂TiC₂Tₓ MXene: The W₂TiAlC₂Tₓ was synthesized by spark plasma sintering (SPS). Commercial powders of tungsten carbide (WC, 45 μm, GoodFellow Aldritch, 99.5%), titanium (Ti, 325 mesh, Alfa Acsar, 99%) and aluminum (Al, 17-30 μm, Alfa Acsar, 99%) were mixed in a molar ratio of WC/Ti/Al=2:1:1.5 in a graphite die coated with boron nitride (BN). The sample in graphite die was then loaded in a Fuji-211lx spark plasma sintering (SPS) and sintered at 1200° C. under 30 MPa for 4 h. The sintered bulk W₂TiAlC₂Tₓ was pulverized in a synthetic sapphire mortar and screened through a 325-mesh sieve to fine W₂TiAlC₂Tₓ powder.

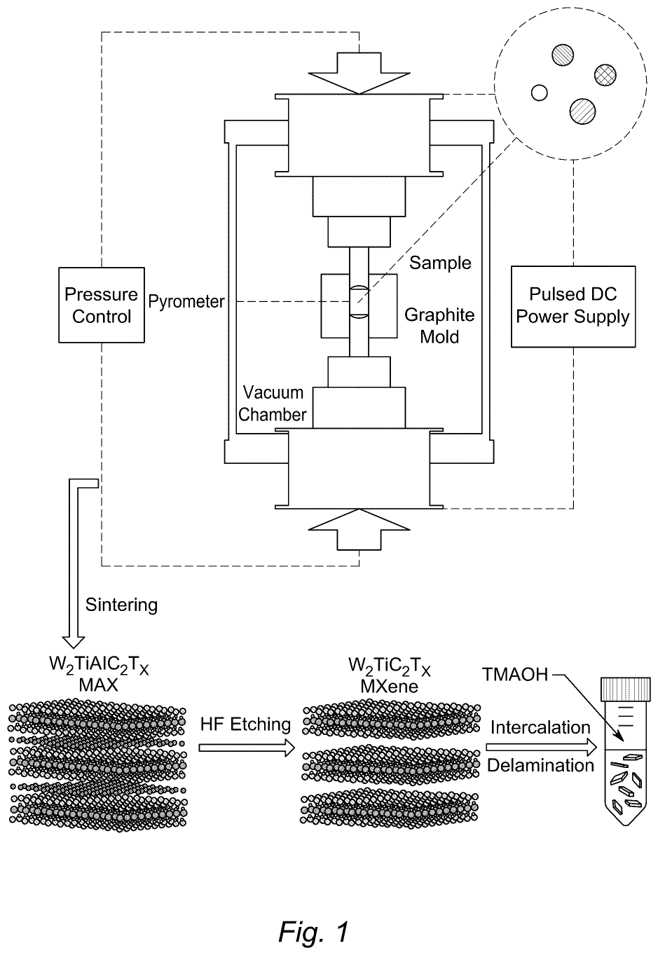

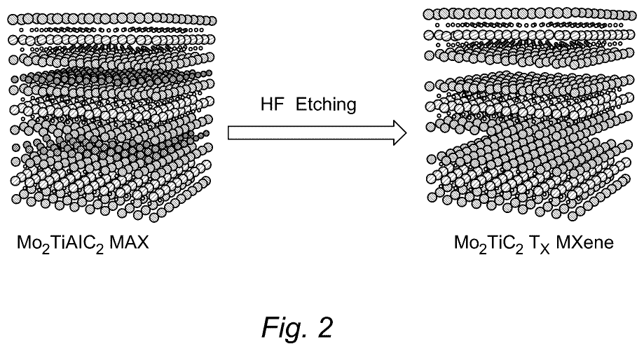

W₂TiC₂Tₓ MXene was prepared by etching W₂TiAlC₂Tₓ powder with hydrofluoric acid. 1.0 g of the obtained W₂TiC₂Tₓ MXene was added into 10 mL of hydrofluoric acid (HF, Sigma Aldrich, 48% in water) and stirred for 72 h at 55° C. in a high-density polyethylene centrifugal tube. The sample was then centrifuged and washed by deionized (DI) water until pH reached 5˜6. The obtained powder was delaminated with 10 ml tetramethylammonium hydroxide (TMAOH, Acros Organics, 25% in water) at 80° C. for 12 h, followed by 6 h sonication. W₂TiC₂Tₓ MXene was collected by centrifugation at 9000 rpm and dried in vacuum. The obtained W₂TiC₂Tₓ MXene was stored in the glove box filled with N₂ for future use (FIG. 1).

Synthesis of Mo₂TiAlC₂Tₓ and Mo₂TiC₂Tₓ MXene: The bulk Mo₂TiAlC₂Tₓ MAX precursor was first prepared by spark plasma sintering of metal powders. Commercial powders of molybdenum (Mo, 1-5 μm, Sigma Aldrich, 99.9%), aluminum (Al, 17-30 μm, Alfa Aesar, 99%), titanium (Ti, 325 mesh, Alfa Acsar, 99%), and graphite (7-11 μm, Alfa Acsar, 99%) were mixed in a molar ratio of Mo/Ti/Al/C=2:1.1:1:1.9 in a graphite die coated with boron nitride (BN). The sample in graphite die was then loaded in a Fuji-211lx spark plasma sintering (SPS) and sintered at 1450° C. under 30 MPa for 1 h. The sintered bulk Mo₂TiAlC₂Tₓ was pulverized in a synthetic sapphire mortar and screened through a 400-mesh sieve to fine Mo₂TiAlC₂Tₓ powder.

Mo₂TiC₂Tₓ MXene was prepared by etching Mo₂TiAlC₂Tₓ powder with hydrofluoric acid (HF, Sigma Aldrich, 48%) at 55° C. for 72 h. The mixture was then washed and centrifuged by deionized water (DI) until pH reached 6 to 7. Mo₂TiC₂Tₓ MXene was collected by centrifugation at 9000 rpm and dried in vacuum. The obtained Mo₂TiC₂Tₓ MXene was stored in the glove box filled with N₂ for further use (FIG. 2).

Characterizations: The X-ray diffraction (XRD) patterns were conducted on a Siemens D500 x-ray diffractometer with Cu Kα radiation source (λ=1.5406 Å). The simulated XRD was obtained by Material Studio and VESTA, and refined withing GSAS software. Field-emission scanning electron microscopy (SEM) images were acquired on FEI Quanta 250. Scanning/transmission electron microscope (STEM) images were acquired on a 200 kV JEOL 2100 STEM. High-resolution, high-angle annular dark field (HAADF) scanning transmission electron microscopy (STEM) imaging was acquired on a Thermo Fisher Spectra 300 probe-corrected S/TEM. X-ray photoelectron spectroscopy (XPS) data was collected on a Thermo Scientific Nexsa G2 XPS system.

### Example 2. Characterization Results

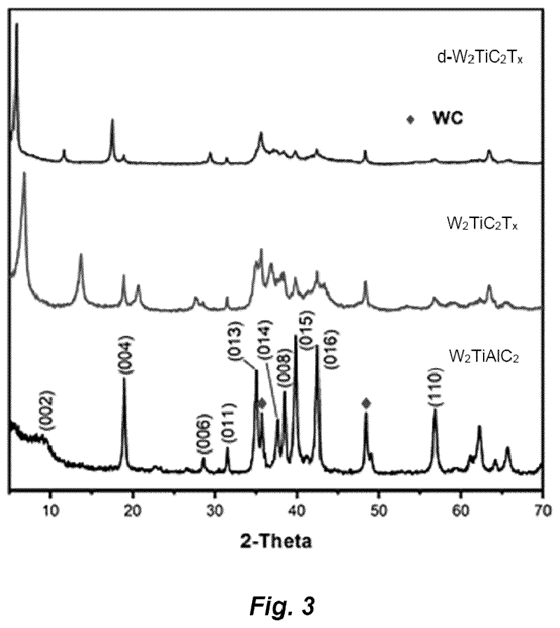

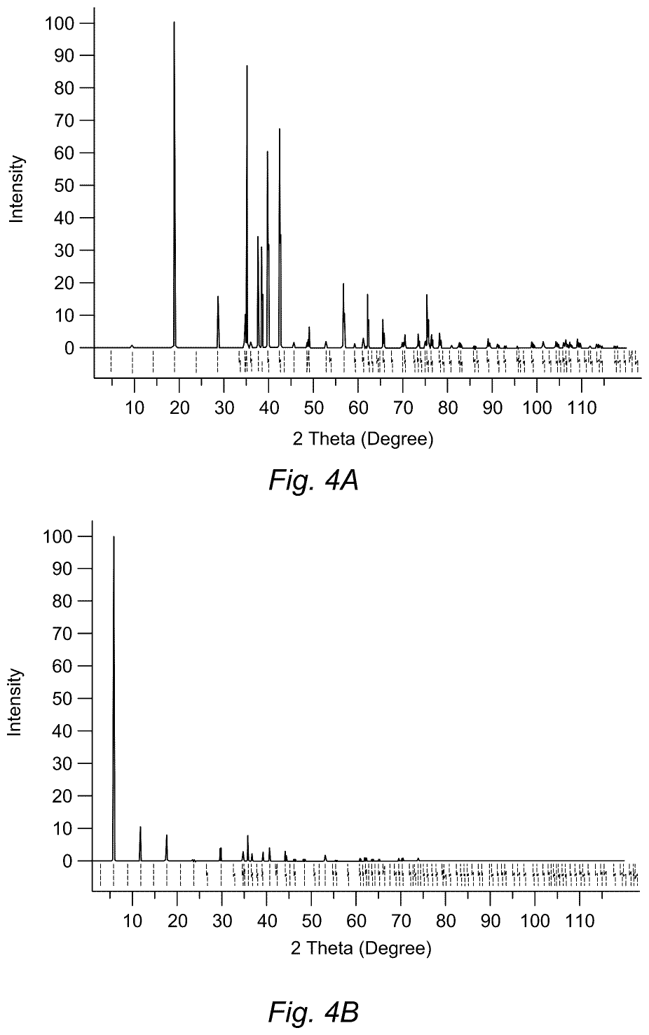

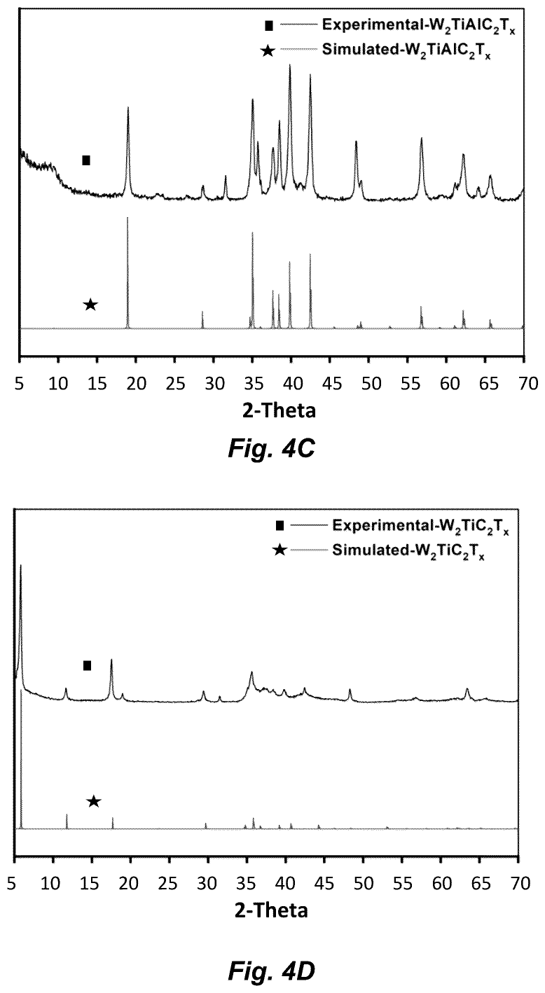

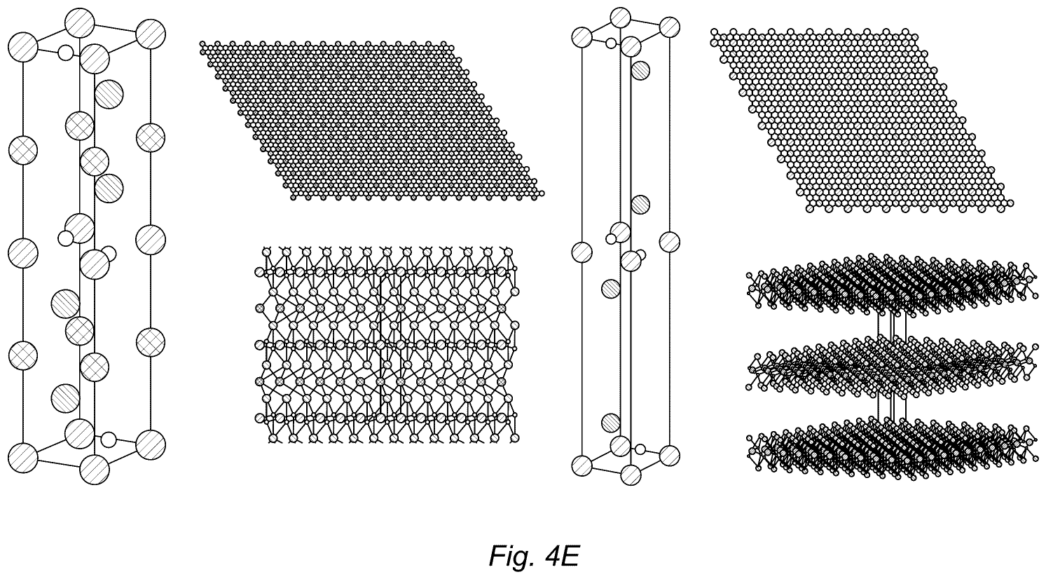

XRD of W₂TiAlC₂Tₓ, and W₂TiC₂Tₓ MXene: The X-ray diffraction (XRD) pattern of W₂TiAlC₂Tₓ shows the characteristic peak of (004) plane at 2θ=19°, the peaks position is in good agreement with the simulated pattern from VESTA, which is generated by importing the lattice parameters derived from the 2θ values of the (110), (101), and (004) peaks in the experimental results. XRD refinement was conducted by GSAS software and the main peaks including (006), (103), (104), (008) and (106) were aligned (FIG. 4c), verified the expected W₂TiAlC₂Tₓ composition and structure was obtained by the synthesis method. The (002) diffraction peak moves to a lower angle (2θ=6.8°) after the HF etching, indicating a larger c lattice parameter (μ-LP) of W₂TiC₂Tₓ due to the removal of Al layers. After delamination with TMAOH, the (002) plane peak shifts further to 2θ=5.85°, consistent with the expansion along the direction. The simulation of W₂TiC₂Tₓ also aligns with the tested XRD, the c-LP increases from to 1.87 nm to 3.01 nm compared with W₂TiAlC₂Tₓ. (FIGS. 3 and 4; Table 1).

TABLE 1
Calculated lattice parameters and atomic coordinates for W₂TiAlC₂Tₓ and W₂TiC₂Tₓ.
W₂TiAlC₂Tₓ
Lattice parameters

| a (Å) | b (Å) | c (Å) | α (°) | β (°) | γ (°) |
|---|---|---|---|---|---|
| 2.98338 | 2.98338 | 18.73010 | 90 | 90 | 120 |

Atomic coordinates

| | W(1) | W(2) | W(3) | W(4) | Ti(1) | Ti(2) | Al(1) | Al(2) | C(1) | C(2) | C(3) | C(4) |
|---|---|---|---|---|---|---|---|---|---|---|---|---|
| x | 0.6667 | 0.3333 | 0.3333 | 0.6667 | 0.0000 | 0.0000 | 0.0000 | 0.0000 | 0.3333 | 0.6667 | 0.6667 | 0.3333 |
| y | 0.3333 | 0.6667 | 0.6667 | 0.3333 | 0.0000 | 0.0000 | 0.0000 | 0.0000 | 0.6667 | 0.3333 | 0.3333 | 0.6667 |
| z | 0.3648 | 0.6352 | 0.8648 | 0.1352 | 0.5000 | 0.0000 | 0.2500 | 0.7500 | 0.4776 | 0.5224 | 0.9776 | 0.0224 |

W₂TiC₂Tₓ
Lattice parameters

| a (Å) | b (Å) | c (Å) | α (°) | β (°) | γ (°) |
|---|---|---|---|---|---|
| 2.98660 | 2.98660 | 30.08700 | 90 | 90 | 120 |

Atomic coordinates

| | W(1) | W(2) | W(3) | W(4) | Ti(1) | Ti(2) | C(1) | C(2) | C(3) | C(4) |
|---|---|---|---|---|---|---|---|---|---|---|
| x | 0.6667 | 0.3333 | 0.3333 | 0.6667 | 0.0000 | 0.0000 | 0.3333 | 0.6667 | 0.6667 | 0.3333 |
| y | 0.3333 | 0.6667 | 0.6667 | 0.3333 | 0.0000 | 0.0000 | 0.6667 | 0.3333 | 0.3333 | 0.6667 |
| z | 0.4063 | 0.5937 | 0.9063 | 0.0937 | 0.5000 | 0.0000 | 0.4776 | 0.5224 | 0.9776 | 0.0224 |

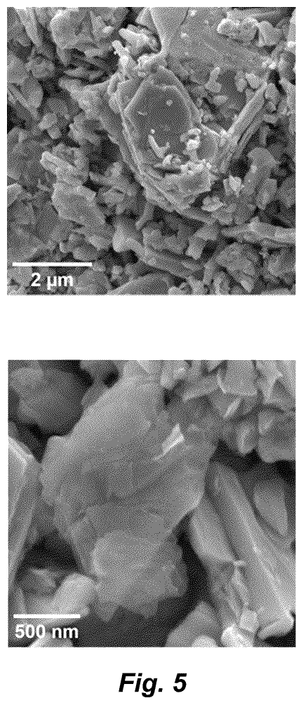

Scanning electron microscopy (SEM) of W₂TiAlC₂Tₓ and W₂TiC₂Tₓ MXene: Images in FIG. 5 show a layered morphology of W₂TiC₂Tₓ.

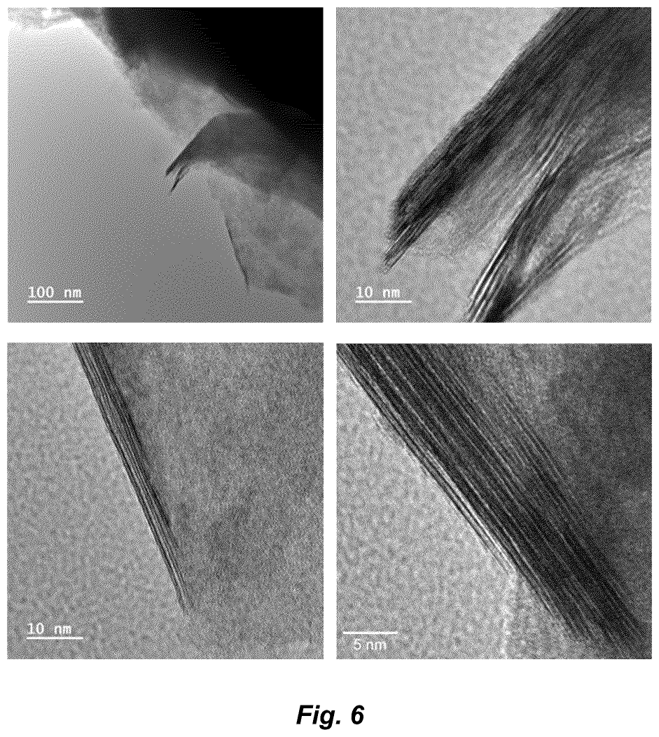

Transmission electron microscopy (TEM) of W₂TiC₂Tₓ: FIG. 6 reveals the two-dimensional structure of MXene. One to several layers of W₂TiC₂Tₓ can be observed at the bent and up-turned edge of nanosheets. The contrast of light and shade layers is consistent with the lateral configuration of alternating transition metal and carbon layers of the M₃C₂Tₓ structure of W₂TiC₂Tₓ.

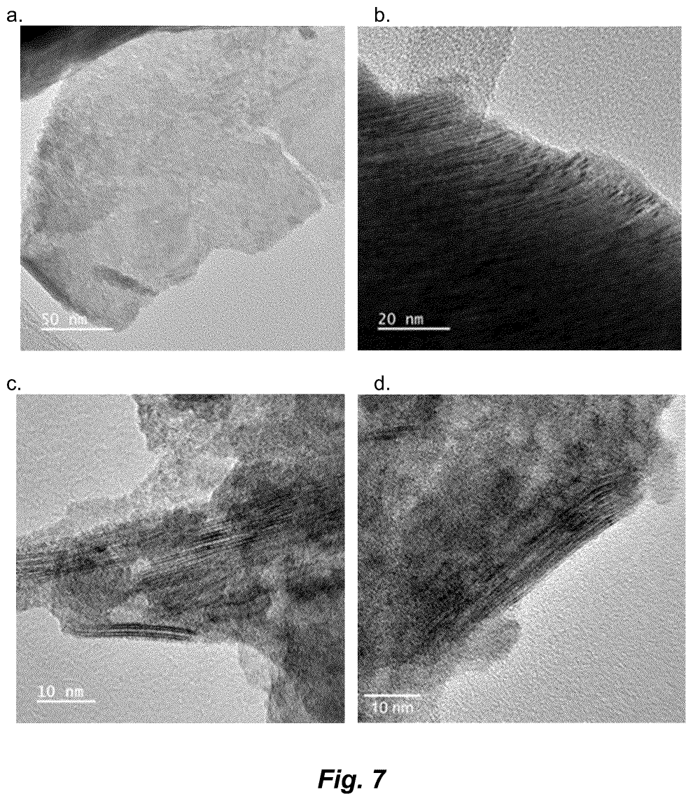

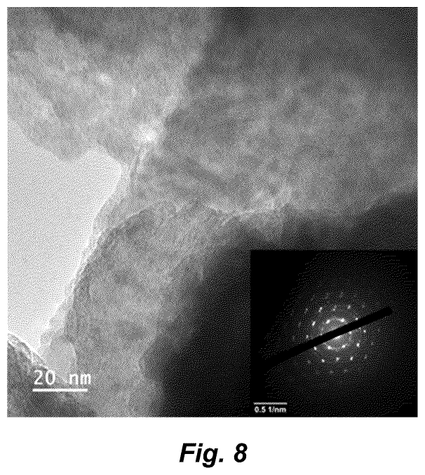

FIG. 7 shows images of W₂TiC₂Tₓ already loaded with different metals, e.g. Co, Cu, and Pt. The loading metals are not distinguished on the structure of the MXene due to lower contrast intensity than the heavy W atoms, as the contrast intensity was approximately proportional to the square of atomic numbers. TEM images from the sideline view present the stacking of W₂TiC₂Tₓ nanosheets. The selected area electron diffraction (SAED) pattern in FIG. 8 confirms the basal plane hexagonal symmetry structure of W₂TiC₂Tₓ.

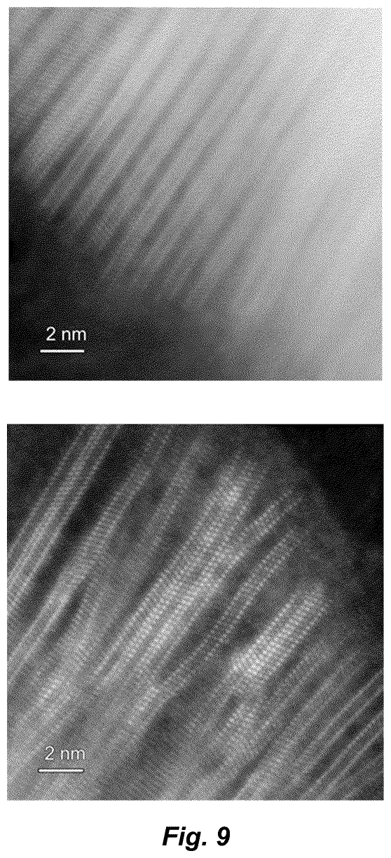

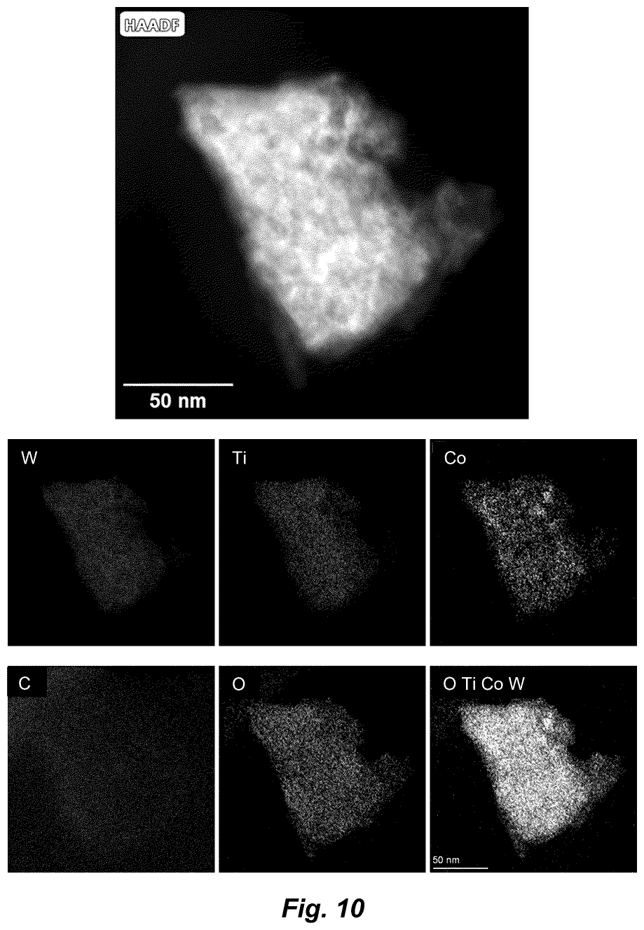

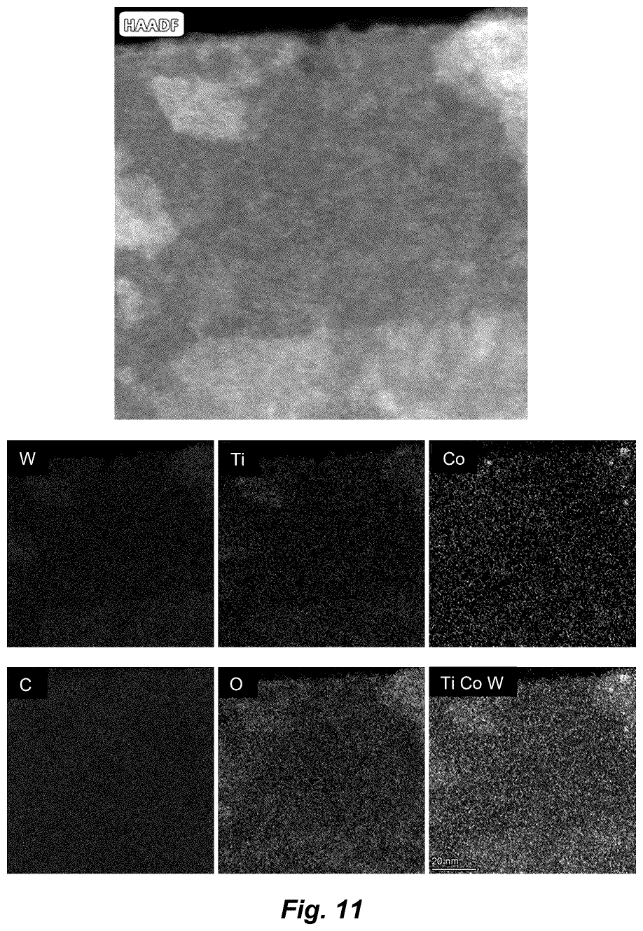

HAADF-STEM of Co/Cu loaded W₂TiC₂Tₓ MXene: High-angle annular dark-field scanning transmission electron microscopy (HAADF-STEM) of W₂TiC₂Tₓ MXene clearly show the ordered double metal layers structure (FIG. 9). The outer and inner metal atom layer can be observed having slightly different contrast, indicating heavier W on the outside and relatively light Ti on the inside, which agrees well with the expected W₂TiC₂Tₓ structure. W₂TiC₂Tₓ loaded with Co keeps the uniform distribution of nanosheets, while that loaded with Cu have recombination between near layers due to reaction with the Cu precursor. Energy dispersive X-ray spectroscopy (EDS) show the W, Ti and loaded metal signals are evenly distributed through the sample without phase segregation (FIGS. 10 and 11).

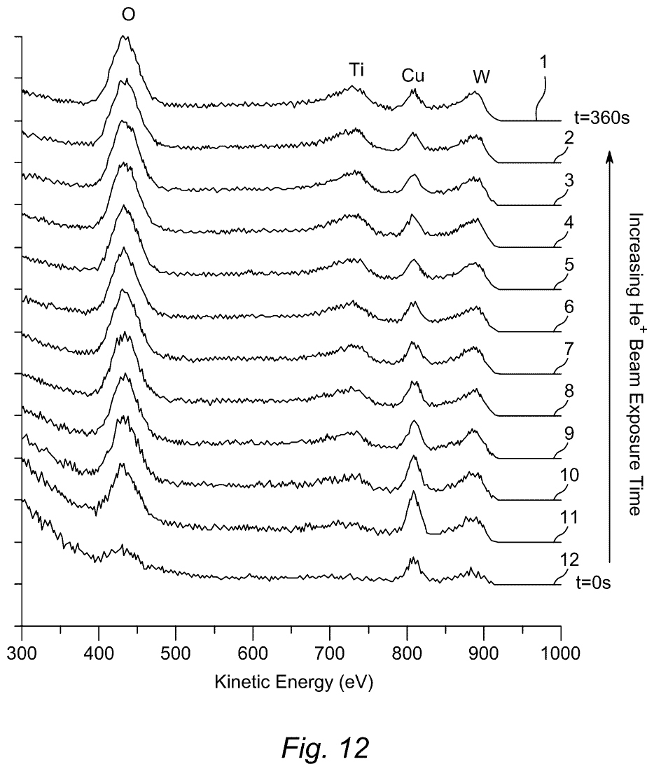

XPS of Cu loaded W₂TiC₂Tₓ MXene: X-ray photoelectron spectroscopy (XPS) and ion scattering spectroscopy (ISS) further reveals the depth profiling of W₂TiC₂Tₓ, with the elemental information provided by the kinetic energy of the scattered helium ions (FIG. 12). The 1 keV He⁺ ISS spectra on Cu/W₂TiC₂Tₓ shows Cu and W but no Ti peak initially at t=0 s, indicates the Ti locating away from the top monolayer of the surface within the sensitive range. With increasing firing time of the helium, the He⁺ beam gradually etches the surface, and the Ti peak becomes visible, validating the ordered structure of W₂TiC₂Tₓ.

### Example 3. Characterizations of Mo₂TiAlC₂Tₓ and Mo₂TiC₂Tₓ MXene

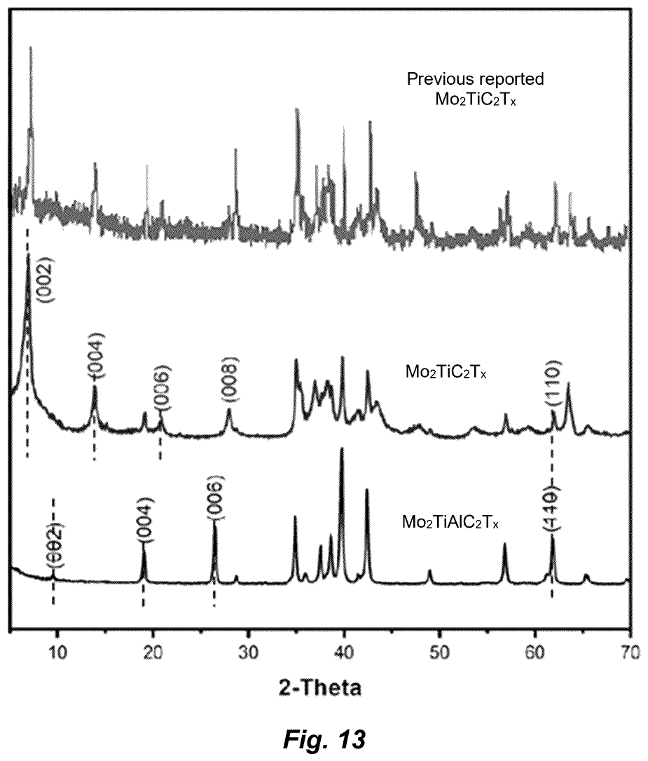

XRD of Mo₂TiAlC₂Tₓ and Mo₂TiC₂Tₓ MXene: The X-ray diffraction (XRD) pattern of Mo₂TiAlC₂Tₓ shows the characteristic diffraction peaks of (002), (004) and (006) plane at 2θ=9.6°, 19.1° and 26.5°. After removing the HF etching, the (002) diffraction peak shifts to a lower angle (from 9.6° to 6.95°), indicating the larger interlayer spacing along the [001] direction. The pattern is in line with previously reported XRD (doi.org/10.1021/acsnano.5b03591), evidenced the successful synthesis of Mo₂TiC₂Tₓ MXene (FIG. 13).

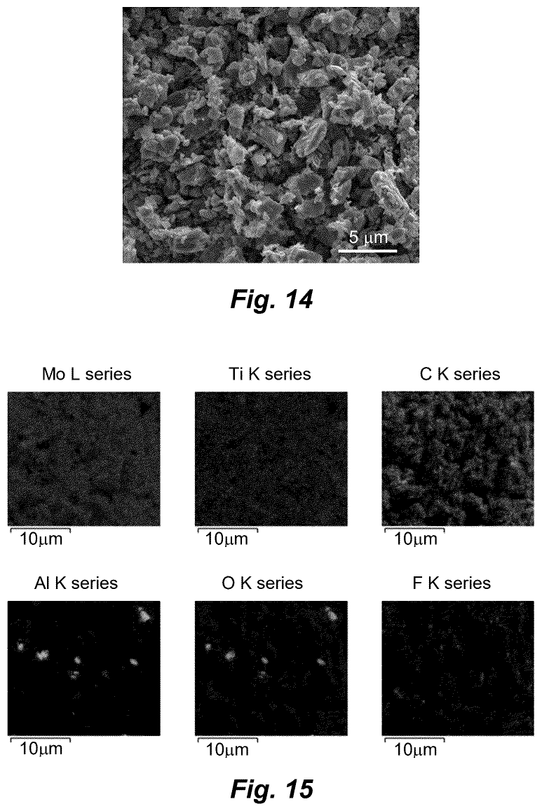

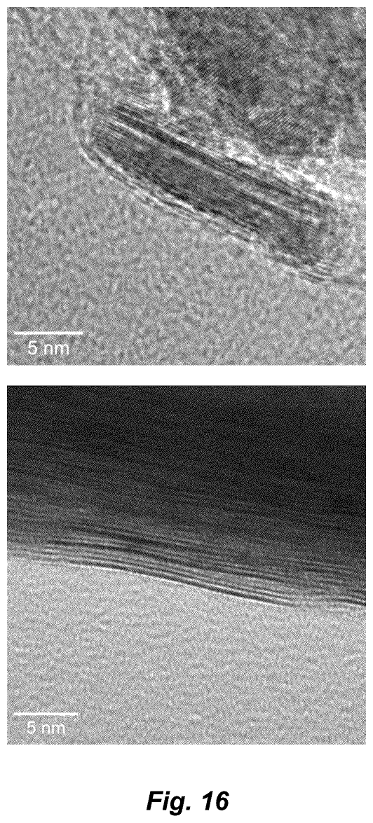

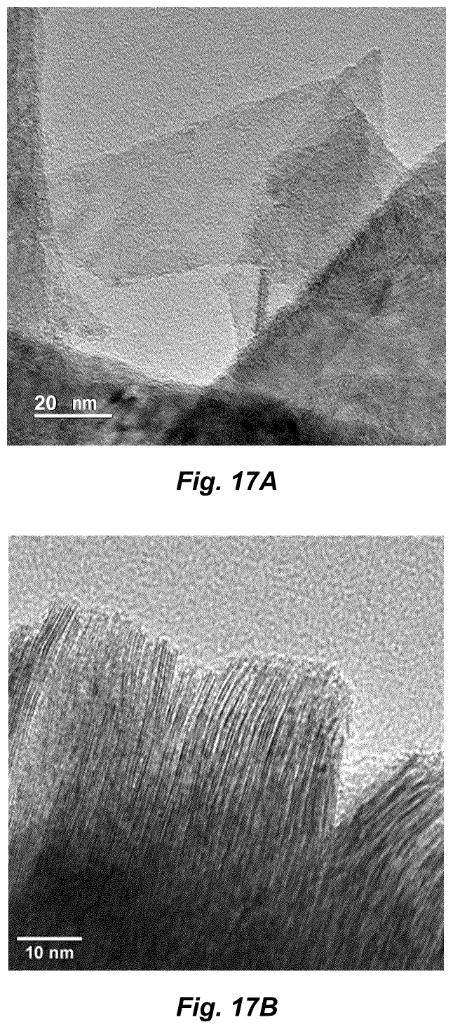

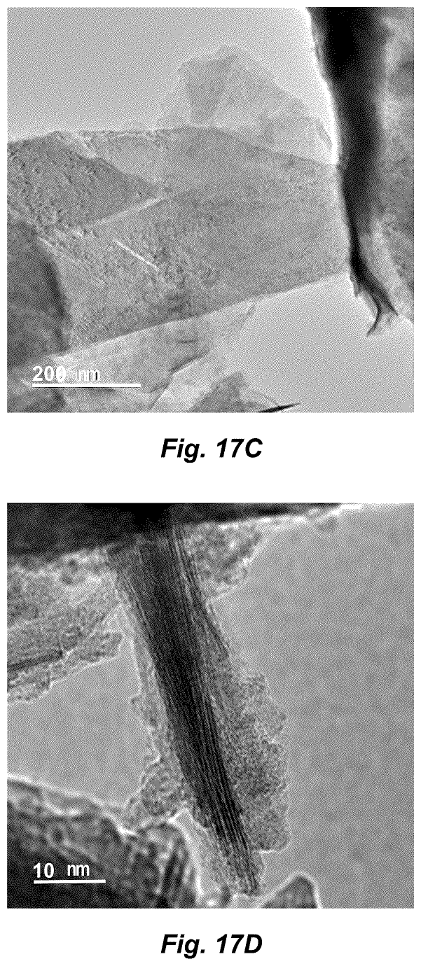

SEM and TEM of Mo₂TiC₂Tₓ MXene: SEM images in FIG. 14 show Mo₂TiC₂Tₓ has layered sheet structure, which is consistent with the typical accordion-like morphology of MXene materials. From the EDS, the Mo (FIG. 15), Ti, and C signals are uniformly distributed through the detecting area. The atomic ratio of the elements from EDS is Mo=26.9%, Ti=13.4%, C=37.3%, O=22.4%, with Mo: Ti molar ratio very close to 2:1. Transmission electron microscopy (TEM) images from the top view show the thin exfoliated Mo₂TiC₂Tₓ nanosheets, and the stacking of MXene layers from sideline view displays good structural integrity after etching (FIGS. 16 and 17).

### Example 4. Plastic Recycling to Fuels

Catalyst Synthesis. For 0.5% Pt/Mo₂TiC₂, 0.5% Cu/Mo₂TiC₂ and 0.5% Cu/W₂TiC₂ catalysts, typically, Pt(NH₃)₄(NO₃)₂ (99.995%, Sigma Aldrich) and Cu(NO₃)₂·6H₂O precursors were dissolved in 1 ml of deionized water (DI) to prepare a solution of 20 mg Pt or Cu per ml. Pt and Cu were loaded on Mo₂TiC₂ and W₂TiC₂ supports via incipient-wetness impregnation. After the impregnation of Pt and Cu, the materials were dried overnight in vacuum at room temperature. For 0.5% Cu-5% WO₃/Mo₂TiC₂, Cu was loaded on to a mixture of 5% WO₃ and 95% Mo₂TiC₂. All fresh catalysts were reduced at 400° C. in a flow of 5% H₂ balanced by Ar prior to reaction tests.

Reaction Tests. A 500 ml high-pressure high-temperature Parr batch reactor was used for the experiments (Parr Instrument Company, Moline, IL). Reactions were conducted at 200-450° C. for 8 hr. In each experiment, 20 g of PE and 5 g of DI water were used. After loading the feed mixture, the reactor was purged with N₂ three times followed by co-feeding 50 cc/min H₂ at 1 bar. The reported reaction time did not include the heating time (10-20 min). After the reaction, air cooling with forced convection was utilized, and it took less than 10 min to below 100° C. Stirring rate at 500 RPM was used through the heating, reaction, and cooling steps. The chemical compositions of both gas and oil samples were determined using gas chromatography (Agilent 6890 GC) coupled with flame ionization detection (GC-FID).

Product Analysis. The gas samples were analyzed using the GS-Carbon PLOT GC Column), and the oil samples were analyzed using the DB-WAX column. The oven temperature was set from 50 to 300° C. with a 5° C./min temperature ramp rate.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A delaminated MXene of Formula IA:
Mₙ₊₁XₙTₓ (IA);
wherein
M is a combination of a period 6 transition metal and an early transition metal;
X is a non-metal wherein the non-metal is carbon or nitrogen;
Tₓ is a surface functional group wherein x is 0-10; and
n is 1-4.

2. The delaminated MXene of claim 1, wherein the period 6 transition metal is tungsten.

3. The delaminated MXene of claim 1, wherein the early transition metal is titanium.

4. The delaminated MXene of claim 1, further comprising late transition metal nanoparticles having a particle size of about 0.5 nm to about 2.0 nm, wherein the late transition metal nanoparticles are uniformly distributed onto a basal plane of the MXene, and wherein the late transition metal is present in less than 5 weight percent based on the total weight of the MXene.

5. The delaminated MXene of claim 4, wherein the late transition metal nanoparticles are about 100% metallic.

6. The delaminated MXene of claim 4, wherein the late transition metal nanoparticles are copper metal nanoparticles, platinum metal nanoparticles, or cobalt metal nanoparticles, and the late transition metal nanoparticles consist of one to five layers of its atoms positioned on the basal plane of the MXene.

7. The delaminated MXene of claim 4, wherein the delaminated MXene is a the delaminated MXene having been annealed at about 450° C. to about 750° C.

8. The delaminated MXene of claim 1, wherein the delaminated MXene is Formula IIA:
W₂TiC₂ (IIA).

9. The delaminated MXene of claim 8, wherein the delaminated MXene comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms.

10. A method for catalytic hydrogenolysis of a polymer comprising:
a) activating a catalyst with a hydrogen source to provide an activated catalyst, wherein the catalyst comprises:
i) a MXene support of Formula I:
Mₙ₊₁XₙTₓ (I);
wherein each M is independently an early transition metal; X is carbon or nitrogen; Tₓ is a surface functional group wherein x is 0-10; and n is 1, 2, 3, or 4; and
ii) a supported metal, wherein atoms of the supported metal occupy crystal lattice nodes at the basal plane of the MXene support, the atoms of the supported metal are supported by metallic bonding to the early transition metal, the supported metal has one to five nanostructured layers of its atoms on the MXene support, and loading of the supported metal on the MXene support is less than 5% w/w based on the weight of the catalyst; and
b) contacting a mixture of the activated catalyst, hydrogen gas, and a polymer at a temperature of at least about 200° C., optionally in the presence of an inert gas, for a period of time that is sufficient for catalytic hydrogenolysis of the polymer;
thereby converting the polymer to a fuel.

11. The method of claim 10, wherein the supported metal is copper, platinum, cobalt, or a combination thereof, and M is titanium, hafnium, niobium, molybdenum, chromium, tungsten, tantalum, vanadium, zirconium, or a combination thereof.

12. The method of claim 10, wherein M is titanium, molybdenum, tungsten, or a combination thereof, and X is carbon and Tₓ is halo, hydroxyl, oxo, or a combination thereof.

13. The method of claim 10, wherein the MXene support is Mo₂ TiC₂ Tₓ or W₂TiC₂Tₓ.

14. The method of claim 10, wherein the loading of the supported metal on the MXene support is about 0.1 wt. % to about 4 wt. %.

15. The method of claim 10, wherein the catalyst is a Mo₂TiC₂Tₓ support loaded with copper or platinum, wherein the copper or platinum loading is about 0.1 wt. % to about 3 wt. %.

16. The method of claim 10, wherein the catalyst is a Mo₂TiC₂Tₓ support loaded with copper, wherein the copper loading is about 0.4 wt. % to about 0.6 wt. %.

17. The method of claim 10, wherein the catalyst further comprises about 3 wt. % to about 8 wt. % of WO₃.

18. The method of claim 10, wherein the catalyst is a W₂TiC₂Tₓ support loaded with copper, wherein the copper loading is about 0.4 wt. % to about 0.6 wt. %.

19. The method of claim 10, wherein the copper or platinum loading is about 0.5 wt. %.

20. The method of claim 10, wherein the polymer comprises polyethylene, polypropylene, or a combination thereof.

21. The method of claim 10, wherein activating the catalyst comprises heating the catalyst and the hydrogen source at temperature above 250° C., wherein the hydrogen source is optionally about a 2% v/v to about a 20% v/v mixture of hydrogen gas combined with an inert gas.

22. The method of claim 10, wherein the mixture is at a temperature of about 225° C. to about 475° C.

23. The method of claim 10, wherein the hydrogen has a flow rate of about 25 cc/min to about 75 cc/min, and the mixture has a pressure of about 1 bar.

24. A method for catalytic hydrogenolysis of a polyolefin comprising:
a) activating a catalyst by heating the catalyst in the presence of hydrogen gas to provide an activated catalyst, wherein the catalyst comprises:
i) a MXene support represented by Formula (II) or Formula (III):
Mo₂TiC₂Tₓ (II);
W₂TiC₂Tₓ (III);
wherein Tₓ is a surface functional group wherein x is 0-10; and
ii) copper metal, wherein atoms of the copper metal occupy crystal lattice nodes at the basal plane of the MXene support, the atoms of the copper metal are supported by metallic bonding to molybdenum or tungsten atoms of the MXene support, the copper metal has one to five nanostructured layers of its atoms on the MXene support, and loading of the copper metal on the MXene support is less than 2% w/w based on the weight of the catalyst; and
b) contacting a mixture of the activated catalyst, hydrogen gas, and a polyolefin at a temperature of at least about 200° C. for a period of time that is sufficient for catalytic hydrogenolysis of the polyolefin;
thereby converting the polyolefin to a fuel.
